(19) United States
(12) Patent Application Publication
(10) Pub. No.: US 2023/0234148 A1
(43) Pub. Date: Jul. 27, 2023

(54) BAND SAW STAND

(71) Applicant: Erik Lovell, Oak View, CA (US)

(72) Inventor: Erik Lovell, Oak View, CA (US)

(21) Appl. No.: 18/093,783

(22) Filed: Jan. 5, 2023

Related U.S. Application Data
(60) Provisional application No. 63/297,340, filed on Jan. 7, 2022.

(51) Int. Cl. B23D 55/02

(52) U.S. Cl. CPC B23D 55/023

(57) ABSTRACT

A portable band saw stand comprising a channel with an upper cradle mounted near one end of the channel and arranged to hold a front handle of a portable band saw. A lower bracket can be mounted at the other end of the channel and arranged to hold a rear handle of the portable band saw, wherein the rear handle comprises a band saw trigger. An on-off trigger mechanism is included that can be mounted to the lower bracket and can be operable to provide an on force to said band saw trigger to turn on said portable band saw. A mounting mechanism is included to mount the channel in a substantially vertical orientation. The band saw stand can also comprise a table that is removable mounted to said channel, wherein the table can be removed from the channel and mounted to the portable band saw to serve as cutting work surface.

This application claims the benefit of U.S. Provisional Patent Application Ser. No. 63/297,340, filed on Jan. 7, 2022.

### BACKGROUND

### Field of the Invention

The present invention relates to powered hand tools and in particular to a stand for mounting a portable band saw in place for use as a stationary band saw.

### Description of the Related Art

Band saws are relatively well-known power tools that are provided with a long, sharp blade consisting of a continuous band of toothed metal stretched between two or more wheels. As the wheels turn, the toothed band moves in continuous direction providing a cutting surface that can be used for cutting different materials in different industries, such as woodworking, metalworking and lumbering.

Conventional band saws come in many different shapes, sizes and forms. For example, standard stationary band saws can be provided with relatively large cabinet and tabletop that provides a stable surface for holding the work to be cut. These saws are typically heavy and designed to be used in place, such as within a workshop.

Portable hand-held band saws have also been developed that can be easily moved and used by hand and can be used outside of the workshop. These saws are relatively small and light and are often provided with a carrying case. This allows the band saws to be easily transported by hand to different locations for use, such as at different job sites.

While these portable band saws are convenient, there are times when it may be desirable to mount portable band saws in place for use, even at different job sites.

### SUMMARY OF THE INVENTION

The present invention is directed to simple, convenient and cost-effective stands for mounting portable band saws in place so that they can be used as one might use a conventional stationary band saw. The present invention provides different stands that can be conveniently mounted in place in different ways and using different mechanisms that give the user flexibility depending on the mounting location. The present invention also includes other improvements, such as an improved on-off triggering mechanism. The present invention also comprises an integral plate/table having an integral storage location for retention of the plate/table. The plate/table can optionally be used for supporting work pieces during cutting.

One embodiment of a band saw stand according to the present invention comprises a channel with an upper cradle mounted near one end of the channel and arranged to hold a front handle of a portable band saw. A lower bracket can be mounted at the other end of the channel and arranged to hold a rear handle of the portable band saw, wherein the rear handle comprises a band saw trigger. An on-off trigger mechanism is included that can be mounted to the lower bracket and can be operable on force to said band saw trigger to turn on said portable band saw. A mounting mechanism is included to mount the channel in a substantially vertical orientation.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 is a front view of one embodiment of a band saw stand according to the present invention;

FIG. 2 is a side view of one embodiment of a band saw stand according to the present invention;

FIG. 3 is a top view of one embodiment of a mounting button according to the present invention;

FIG. 4 is a side view of the mounting button shown in FIG. 3;

FIG. 5 is a partial side view of the mounting button shown in FIG. 3;

FIG. 6 is a bottom perspective view of the mounting button shown in FIG. 3;

FIG. 7 is a top perspective view of the mounting button shown in FIG. 3;

FIG. 8 is a side perspective view of one embodiment of a band saw stand according to the present invention;

FIG. 9 is upper perspective view of one embodiment of a band saw stand according to the present invention;

FIG. 10 is a perspective view of the channel and table according to one embodiment of a band saw stand according to the present invention;

FIG. 11 is an upper perspective view of the channel and table according to one embodiment of a band saw stand according to the present invention;

FIG. 12 is a side view of a table spring according to the present invention;

FIG. 13 is a mounting schematic for one embodiment of a band saw holder according to the present invention;

FIG. 14 is a perspective view of one embodiment of a band saw holder according to the present invention holding a portable band saw;

FIG. 15 is another perspective view of embodiment of a band saw holder according to the present invention holding a portable band saw;

FIG. 16 is a side view of one embodiment of an upper cradle that can be used in different band saw stand embodiments of the present invention; and

FIG. 17 is a back view of one embodiment of an on-off trigger used in embodiments of the present invention.

### DETAILED DESCRIPTION

The present disclosure will now set forth detailed descriptions of various embodiments of portable band saw stands according to the present invention. As described in detail below, band saw stands can include many different features that allow for safe and convenient use of portable band saws mounted in place to operate similar to conventional non-portable band saws. Different embodiments of the band saw stands according to the present invention can comprise different mechanisms for holding the band saw stand in place for use. This provides flexibility in how the stand is used and allows the stand to hold the band saw in many different location and to many different surfaces.

In some embodiments, the band saw stand according to the present invention can comprise mounting buttons that can be affixed to a vertical surface with the appropriate distance between the buttons to mate with mounting holes in the band saw stand. The band saw stand can be easily mounted to the vertical surface at the buttons by resting the stand on the buttons at the mounting holes. The buttons can be mounted on the vertical surface at different heights to allow for use of the band saw stand at different heights. In some embodiments, multiple pairs or groups (“pairs”) of buttons can be provided, with each of the pairs working together to mount the band saw stand at a particular height. Each of the pairs of buttons can provide for a different mounting height for the band saw stand.

In other embodiments, the band saw stand can be mounted to a vertical surface by screws that pass-through screw holes in the stand. In still other embodiments, the band saw stand can comprise an F-clamp with a vertical surface having mounting buttons. The F-clamp can be mounted to a horizontal surface, and the remainder of the band saw stand can be mounted to the buttons on the vertical surface. The band saw stand can be mounted to still other surfaces using clamps such as vice grips These are only some of the mounting devices that can be provided in band saw stands according to the present invention.

The band saw stands according to the present invention include other features and advantages that allows for easy, safe and convenient use of portable band saws in a fixed position. The band saw stand conveniently engages with the portable band saw, such as at the upper and lower handle features of a band saw. Other embodiments can engage other integral features of the portable bandsaw which may allow for it's safe and reliable mounting. These arrangements allow for stable engagement between the portable band saw and the band saw stand, yet allows the portable band saw to be easily removed from the portable stand. This allows the portable band saw to be easily used between stationary (in the band saw stand) and free-hand use.

The band saw stand according to the present invention can also comprise other features, such as a convenient on/off trigger, and a built-in storage for a plate that can be removed from its storage location and mounted to the band saw when in the band saw stand. The plate can then be used to support the material being cut by the saw. These are only some of the features that can be included in the band saw stands according to the present invention.

Throughout this description, the preferred embodiment and examples illustrated should be considered as exemplars, rather than as limitations on the present invention. As used herein, the term “invention,” “device,” “present invention,” or “present device” refers to any one of the embodiments of the invention described herein, and any equivalents. Furthermore, reference to various feature(s) of the “invention,” “device,” “present invention,” or “present device” throughout this document does not mean that all claimed embodiments or methods must include the referenced feature(s).

It is also understood that when an element or feature is referred to as being “on” or “adjacent” to another element or feature, it can be directly on or adjacent to the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms, such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

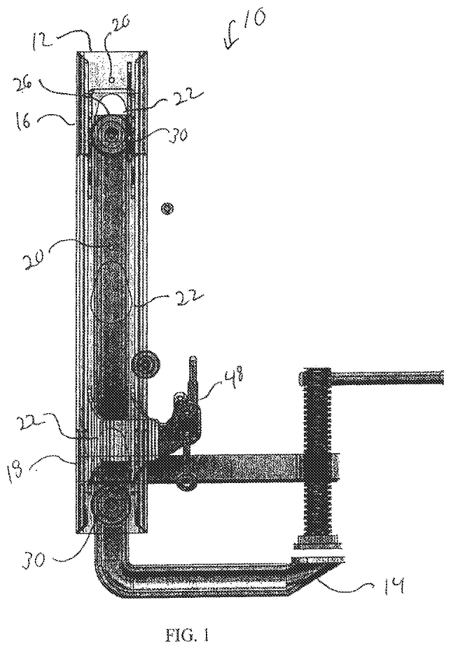

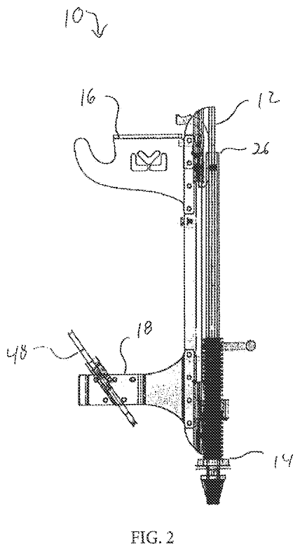

FIGS. 1 and 2 show one embodiment of a band saw stand 10 according to the present invention that comprises a channel 12 and an integral F-clamp 14. The stand 10 further comprises an upper cradle 16 and a lower bracket 18. In some embodiments the F-clamp is used in mounting the band saw stand 10 as described below. In other embodiments, band saw stand can be mounted without use of the F-clamp 14. In those where the F-clamp is not used, the channel 12 comprises features for mounting to a vertical surface such as a wall, including screw holes 20 that are arranged for screws (not shown) to pass through to turn into the vertical surface. This provides a rugged and relatively permanent mounting of the stand 10 to the vertical surface.

The channel 12 also includes a plurality of button holes 22 that can also be used to mount the stand to a vertical surface, such as a wall. The button holes 22 are separated along the length of the channel 12, with the embodiment shown having three button holes 22. In the embodiments shown, there are three button holes 22 along the channel 12, but in other embodiments fewer or more button holes can be used. Each of the button holes 22 is arranged to mate with a button that has been mounted to the vertical surface in the desired mounting location. In some embodiments there can be the same number of mounting buttons as button holes 22, while in other embodiments there can be fewer buttons as mounting button holes 22.

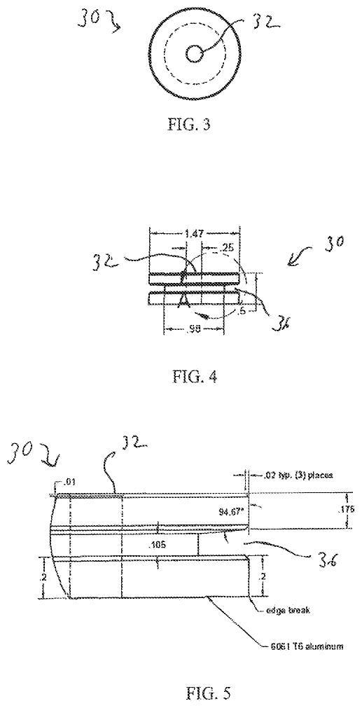

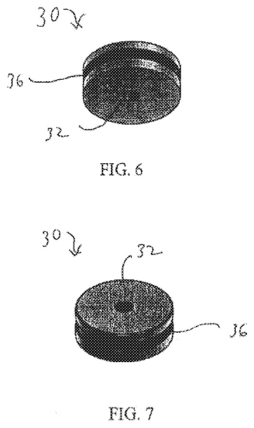

Many different mounting buttons can be used having many different shapes and sizes. FIGS. 3-7 show one embodiment of mounting button 30 according to the present invention that can be mounted to the vertical surface by a screw passing into the vertical surface through the button screw hole 32. Each of the mounting buttons 30 can be mounted in a location to mate with one of the button holes 22. Each of the mounting buttons 30 also comprises a radial channel 36, and when the band saw stand 10 is mounted to the button 30, the edge of the button hole 22 rests in the button's radial channel 36.

In the embodiment shown, the button holes 22 can have a wider lower portion and a narrower upper portion. This wider portion allows for a mounting button 30 to pass into its mounting hole, and then as the band saw stand moves down the narrow portion of the button holes 22 fit in the radial channel 36. Accordingly, the buttons are mounted to the vertical surface with a spacing to mate with the button holes 22. When mounting, the stand 10 can be held over the holes 22 and moved toward the vertical surface with the mounting buttons 20 passing through the wider portion of the button holes 22. The stand is then moved down to move the narrower portion of the button holes 22 into the radial channel 36. This provides for reliable mounting of the band saw stand 10 to the mounting buttons. These steps taken to mount the stand 10 to the buttons 30 can be taken in reverse to remove the stand 10 from the buttons 30.

As mentioned above, the mounting buttons 30 can be mounted at different heights to allow for mounting and use of the band saw stand 10 at different heights. By having three button holes 22 in the rear of the channel 12 (such as 6 inches apart) that band saw stand 10 can be positioned up or down to adjust the height of the saw for user preference. In most embodiments, at least two mounting buttons 30 would be used to provide for stable horizontal and vertical holding of the stand 10 during use. It is understood that the vertical surface can comprise a wall or similar surface, but the buttons 30 can also be mounted to a portable free-standing pedestal base for benchtop use.

Other embodiments of the band saw stand 10 according to the present invention can also comprise an F-clamp 14, with features for mounting the stand to the F-clamp 14. In some embodiments according to the present invention, the F-clamp 14 can comprise an integral vertical surface 26 with mounting buttons 30. The mounting buttons 30 can be integral to the vertical surface 26, or can be mounted to the vertical surface 26 using different mounting devices such as screws, bolts, adhesive, etc. This F-clamp 14 and vertical surface arrangement might be used in applications where there is no convenient location for mounting the buttons directly to a wall or other similar feature. The vertical surface 26 provides the location for convenient mounting of the band saw stand 10.

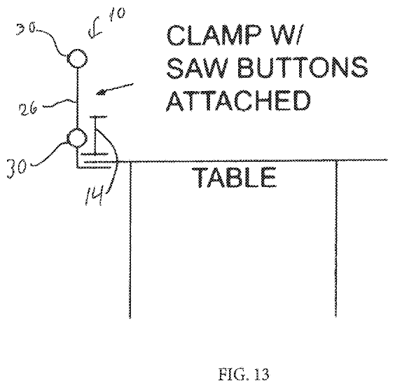

The F-clamp 14 can be affixed to a horizontal surface, such as a work bench and the vertical surface 26 can be used for mounting of the band saw stand 10 at the buttons 30. Referring now to FIG. 13, a schematic is provided showing this arrangement. The F-claim 14 can be mounted to a horizontal surface of a table or work bench 28. The vertical surface 26 comprises the mounting buttons 30, with the F-clamp holding the vertical surface 26 in place. The stand 10 can then be mounted to the vertical surface 26 at the mounting buttons 30 as described above.

As mentioned above, the stand can also be mounted to surfaces where there is no convenient location to mount the mounting buttons 30 or to mount the F-clamp 24. These embodiments can use other mounting mechanisms such as vice-grips to mount the stand 10 in place to surfaces at different angles. This vice grip mounting would be appropriate for example, at a single day use at a job site away from a shop.

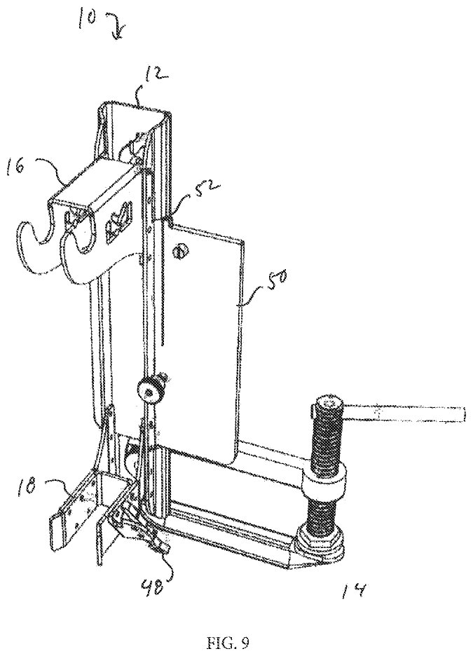

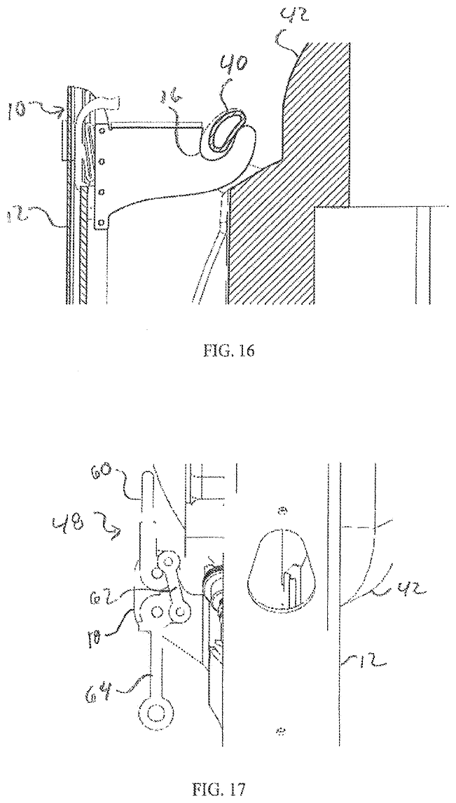

Referring now to FIGS. 2, 8, 9 and 14-16, the upper cradle 16 is shown that is sized and positioned so that the front handle 40 (shown in FIGS. 14-16) of the portable band saw 42 can rest in the cradle 16. The rear handle 44 of the portable band saw 42 is held in the lower bracket 18, with the weight of band saw 42 and the shape of the cradle 16 and bracket 18 keeping the front handle 40 and rear handle 44 in the cradle 16 and bracket 18, respectively. The portable band saw 42 can be removed by lifting the front handle 40 out of the cradle 16. It is understood that in other embodiments, one or both of the cradle 16 and bracket 18 can be arranged with a feature or component to hold their respective portion of the band saw 42. This can include components such as a bracket, pin or skewer, but many other components can be used.

It is understood that the stand 10 can have a cradle and bracket that are arranged to be compatible with multiple portable band saws. Alternatively, different stands could be provided, each of which is customized for a different portable band saw.

The stand 10 further comprises on-off trigger 48 that engages the on-off button of the portable band saw when mounted in the band saw stand. The on-off trigger 48 can comprise an over-center linkage mechanism and provides the advantage of an on-off trigger 48 having an “up” action to turn the saw on, and a “down” action to turn the saw off. This follows the industry standard for on-off action used with most cabinet and non-portable band saws. This gives the band saw stand 10 the same on-off feel as non-portable band saws.

One embodiment of an on-off trigger 48 is shown in shown in FIG. 17, and in some embodiments the trigger 48 can be mounted to the lower bracket 18. The on-off trigger 48 is shown in relation to the channel 12 and the band saw 42. The trigger 48 is arranged to operate with the same on-off feel of non-portable band saws and comprises an input lever 64, a link 62, and an output lever 60 for engaging the trigger of the saw 42. The link 62 is rotationally mounted to the input lever 64 at the bottom and the output lever 60 at the top. During operation, as the input lever 64 is moved up and clockwise the link 62 provides a clockwise downward motion on the output lever 60, which can provide a downward force to press the saw trigger on and turn the band saw on. When the input lever 64 is then moved down or in a counterclockwise direction, the link 62 moves the output lever 60 counterclockwise and away from the band saw trigger. This in turn removes the downward force to the saw trigger and allows the band saw to turn off. This is only one of the many arrangements that can be used with the band saw stand to provide the up-on and down-off action that follows non-portable band saws.

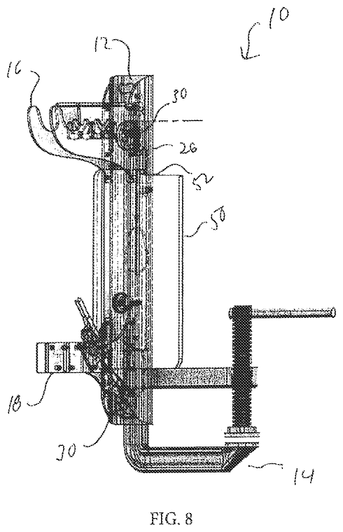

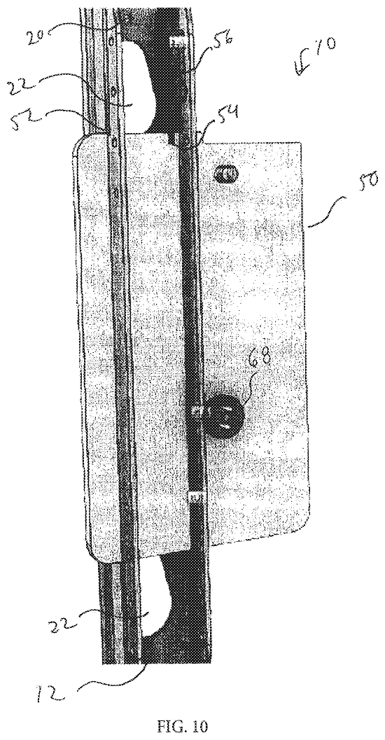

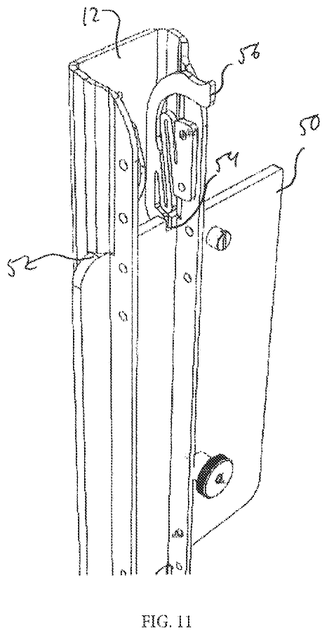

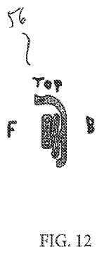

Referring now to FIGS. 8-12, 14 and 15, the stand 10 can further comprise an integral table 50 that is held in a table slot 52 in the channel 12 for storage. The table 50 can be removed from the slot 52 and used to hold the material being cut or otherwise worked on by the saw. As best shown in FIG. 10, the table can have an upper notch 54 that cooperates with a holding spring 56 to hold or release the table 50 from the notch 54 so that the table 50 can be removed from the slot 52. This arrangement allows for convenient storage of the table 50 when not in use and for easy removal from the slot when the table 50 is to be used. As best shown in FIG. 12, the holding spring 56 can be arranged so operating the top surface of the spring 56 allows for front and back motion of the springs latching surface to move between the hold and release position. It is understood that the holding spring is just one of the many different holding features that can be included in different embodiments of the present invention, and that the plate can be stored in many different locations and used in many different ways.

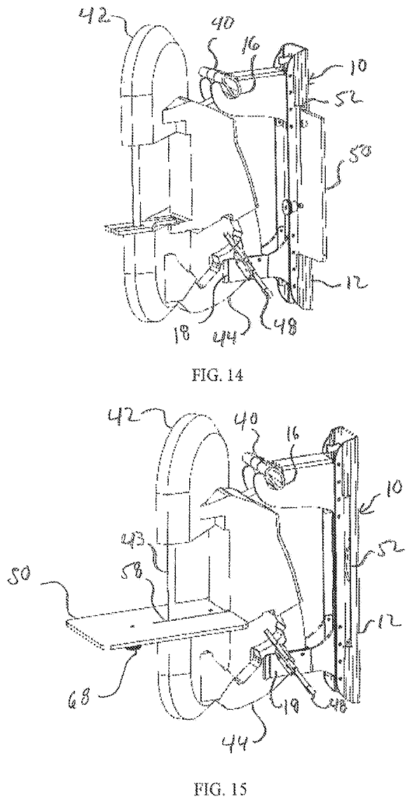

As best shown in FIG. 15, once the table 50 is removed from the slot 52 it can be mounted to the saw 42 in a location that provides for a horizontal surface to hold the work being cut. Many different mounting mechanisms can be used, such as a screw, bolt or bracket, with the embodiment shown using a hand tightened screw 68 that is arranged to cooperate with a feature of the band saw 42 to hold the table 50 in the desired location. The table 50 also has a blade slot 58 that is arranged so that that cutting band 43 of the saw 42 can pass through the inner portion of the table 50. This allows the table 50 to provide a horizontal surface around the cutting band 43.

Although the present invention has been described in detail with reference to certain preferred configurations thereof, other versions are possible. For example, different embodiments have features that are adjustable so that the band saw stand fits different sized portable band saws. The upper cradle and lower bracket can be adjustable in the channel, and the on-off trigger can be moved or adjusted to fit different portable band saws.

Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention, wherein no portion of the disclosure is intended, expressly or implicitly, to be dedicated to the public domain if not set forth in any claims.

We claim:

1. A band saw stand, comprising:
a channel;
an upper cradle mounted near one end of said channel and arranged to hold a front handle of a portable band saw;
a lower bracket mounted near the other end of said channel and arranged to hold a rear handle of said portable band saw, wherein said rear handle comprises a band saw trigger;
an on-off trigger mechanism mounted to said lower bracket and operable with an upward motion to provide an on force to said band saw trigger to turn on said portable band saw, and operable in a downward motion to remove said on-force; and
a mounting mechanism to mount said channel in a substantially vertical orientation.

2. The band saw stand of claim 1, wherein said mounting mechanism comprises a plurality of buttons, each of which is arranged for mounting on a substantially vertical surface.

3. The band saw stand of claim 2, wherein said channel comprises button holes each of which is arranged to cooperate with one of said buttons to mount said stand in said substantially vertical orientation.

4. The band saw stand of claim 1, wherein said channel comprises screw holes to mount said channel in a substantially vertical orientation.

5. The band saw stand of claim 1, further comprising a clamp to mount said channel in said substantially vertical orientation.

6. The band saw stand of claim 1, wherein said clamp comprises an integral vertical surface with buttons.

7. The band saw stand of claim 5, wherein said clamp comprises an F-clamp.

8. The band saw stand of claim 1, wherein said on force is a downward force.

9. The band saw stand of claim 1, further comprising a table held in a table slot in the channel.

10. The band saw stand of claim 9, wherein said table is removable from said table slot and mountable to said band saw in a substantially horizontal orientation.

11. A portable band saw mounting system, comprising:
a portable band saw;
a band saw stand to hold said portable band saw in a substantially vertical orientation, comprising:
an upper cradle arranged to hold a front handle of a portable band saw;
a lower bracket arranged to hold a rear handle of said portable band saw, wherein said rear handle comprises a band saw trigger; and
an on-off trigger mechanism mounted to said lower bracket and operable with an upward motion to provide an on force to said band saw trigger to turn on said portable band saw, and operable in a downward motion to remove said on-force.

12. The system of claim 11, further comprising a channel, wherein said upper cradle and lower bracket are mounted to said channel.

13. The system of claim 12, further comprising a mounting mechanism to mount said channel in a substantially vertical orientation.

14. The system of claim 13, wherein said mounting mechanism comprises a plurality of buttons, each of which is arranged for mounding to a substantially vertical surface.

15. The system of claim 14, wherein said channel comprises button holes each of which is arranged to cooperate with one of said buttons to mount said band saw stand in a substantially vertical orientation.

16. The system of claim 13, wherein said channel comprises screw holes to mount said channel in a substantially vertical orientation.

17. The system of claim 13, further comprising a clamp to mount said channel in said substantially vertical orientation.

18. The system of claim 17, wherein said clamp comprises an integral vertical surface with buttons.

19. The system of claim 12, further comprising a table removably mounted to said channel.

20. A band saw stand, comprising:
a channel;
an upper cradle mounted near one end of said channel and arranged to hold a front handle of a portable band saw;
a lower bracket mounted at the other end of said channel and arranged to hold a rear handle of said portable band saw, wherein said rear handle comprises a band saw trigger;
an on-off trigger mechanism mounted to said lower bracket;
a mounting mechanism to mount said channel in a substantially vertical orientation; and
a table removably mounted to said channel and removable from said channel to mount to or adjacent to said portable band saw.
